(19) United States
(12) Patent Application Publication
(10) Pub. No.: US 2009/0106881 A1
(43) Pub. Date: Apr. 30, 2009

(54) METHOD AND KIT FOR COMMUNICATION USING A LEG COVERING

(76) Inventor: Richard J. Delinski, Woodbridge, VA (US)

Correspondence Address: ADVANTIA LAW GROUP, 9035 SOUTH 1300 EAST, SUITE 200, SANDY, UT, 84094, US

(21) Appl. No.: 12/347,719

(22) Filed: Dec. 31, 2008

Related U.S. Application Data
(63) Continuation of application No. 11/611,035, filed on Dec. 14, 2006.

(51) Int. Cl. A41B 11/04; A41D 27/08; A41D 27/00; G09F 21/02

(52) U.S. Cl. 2/409; 2/244; 2/243.1; 40/586

(57) ABSTRACT

A method and kit for communication using a leg covering. The method includes: selecting a one or more graphical displays presenting a desired message; removably coupling the graphical display via a coupling mechanism to a thigh portion of a leg covering normally covered by another article of clothing; and selectably displaying the graphical display. The one or more graphical displays may comprise a game; evoke a particular emotional response; include textual or graphical images; and/or may comprise a color contrasting to the leg covering. The kit for communication using a leg covering includes a leg covering and a communication system which includes: one or more graphical displays and a coupling mechanism. The one or more graphical displays may be removably coupled to a portion of the leg covering selected from the groups consisting of: a thigh portion, a calf portion, a shin portion, and a knee portion.

### CROSS-REFERENCE TO RELATED APPLICATIONS

This application claims priority to and is a continuation of application Ser. No. 11/611,035 by Richard J. Delinski and filed on 14 Jan. 2006. This invention claims priority, under 35 U.S.C. § 120, to the U.S. Provisional Patent Application No. 60/754,758 filed on Dec. 28, 2005, which is incorporated by reference herein.

### BACKGROUND OF THE INVENTION

1. Field of the Invention

The present invention relates to methods and devices of communication using articles of clothing, specifically leg coverings.

2. Description of the Related Art

In the related art, T-shirts, pants, shoes, and other articles of clothing are often used to communicate messages. This communicating is often accomplished via graphical displays of pictures, logos, text, words, and/or any combination thereof. The messages communicated are often related to advertising or promoting a certain brand-name of clothing. Typically, a graphical display or text message on clothing does not communicate the feelings and/or desires of the user of the clothing. In some instances, however, a person may buy clothing with a message and/or graphical display that communicates a person's desired message.

Leg coverings are not typically used to communicate a message to others, and therefore, typically do not contain any type of graphical display and/or messages. Furthermore, the graphical displays and/or messages on leg coverings, like socks, are mainly directed toward brand names, company logos, and/or promoting the brand of the product. Additionally, these graphical displays are typically sew into the leg coverings or otherwise coupled to the leg covering in such a way that precludes easy removal of the graphical display by a user.

Some improvements have been made in the field. Examples include but are not limited to the references described below, which references are incorporated by reference herein:

U.S. Pat. No. 6,408,445, issued to Matthews, discloses a panty leg attachment device, a panty garment combined with the device, and a panty/combination leg covering garment utilizing the device enables the securement of the open end of a tubular leg covering garment to a leg opening of a panty garment. The device in one embodiment is formed from a panty inner band with first and second sides, the first inner band side affixed to the panty garment inner side and the second inner band side having securing means in the form of tape segments positioned thereon. A panty outer band having first and second sides has its second side secured to the panty garment outer side and carries a scalloped decorative edge along its perimeter. A tubular leg covering garment elastic band with first and second sides is secured along its first side to the first inner band side at the leg garment open end and the second side has a plush covering releasably securable to the panty garment second inner band tape segments which cooperate to hold the leg covering garment in a substantially fixed relationship with the panty, while the panty and leg covering garment are being worn. Another embodiment includes a foldable elastic segment secured to the leg opening of the panty garment which form inner and outer bands that cooperate to grasp the tubular leg covering garment elastic band which carry tape segments with microfine hook fasteners positioned thereon. The attachment device secures the panty garment leg opening to the open end of the tubular leg covering garment and conceals the secured ends from view to form a fashionable garment.

U.S. Pat. No. 5,667,248 issued to Mayer, discloses a Greeting card in which portions of messages are obscured by one or more detachable covers, so that the messages are revealed when the covers are moved.

U.S. Design Pat. No.: USD493,031, issued to Thomas, discloses an ornamental design for a leg covering for a human's legs, as shown and described.

U.S. Design Pat. No.: USD500,918, issued to Thomas, discloses an ornamental design for a leg covering for a human's legs, as shown and described.

The inventions heretofore known suffer from a number of disadvantages which include: having no graphical display and/or design, having no easily removable graphical display and/or design, not communicating a message via the leg covering, and/or so forth.

What is needed is a method and kit of communication using a leg covering that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available leg coverings. Accordingly, the present invention has been developed to provide a method and/or kit of communication using a leg covering that can be used in any type of leg covering, such as, but not limited to, panty hose, knee-high socks, and/or so forth. The present invention has further been developed to provide an easily detachable means of communication via a leg covering; allowing a user to mix and match different messages and/or graphical displays. The present invention enables a user to easily attach and/or remove a graphical display from a leg covering.

In one embodiment there is a method for communication using a leg covering which may comprise: selecting a graphical display presenting a desired message; removably coupling the graphical display via a coupling mechanism to a thigh portion of a leg covering normally covered by another article of clothing; and/or selectably displaying the graphical display. The method may further include selecting a plurality of graphical displays and/or removably coupling a plurality of graphical displays to a leg a covering. Additionally, the method may comprise a game. The method may further include the use of panty hose as a leg covering.

In another embodiment, the method may include a coupling mechanism, configured to couple a graphical display to a leg covering. The coupling mechanism may include a hook and/or loop mechanism. The graphical display may be configured to cause a particular emotional response. Additionally, the graphical display may include text and/or a color contrasting the color of the leg covering. Further, the plurality of graphical displays may be removably coupled to a portion of the leg covering selected from the group consisting of: a thigh portion, a knee portion, a calf portion, and/or a shin portion.

In yet another embodiment, the method for communication using a leg covering may comprise: wearing a leg covering including a graphical display which may be easily removably couplable to the thigh portion of the leg covering; and/or selectably covering and/or uncovering the graphical display. The method may further include selecting a plurality of graphical displays and/or removably coupling a plurality of graphical displays.

In still another embodiment, there is a kit for communication using a leg covering which may comprise: a leg covering, configured to fit over a user's leg; and/or a communication system. The communication system may include: a graphical display removably couplable to the leg covering at a location un-coverably covered by an article of clothing; and/or a coupling mechanism, configured to removably couple the graphical display to the leg covering. The kit may further include a graphical display which may be removably couplable to the thigh portion of the leg covering.

In another embodiment, the kit for communication using a leg covering may include a plurality of graphical displays removably couplable to the leg covering. Additionally, the plurality of graphical displays may comprise a game. Further, the leg covering may be panty hose and/or the coupling mechanism may include a hook and/or loop.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). Understanding that these drawing(s) depict only typical embodiments of the invention and are not therefore to be considered to be limiting of its scope, the invention will be described and explained with additional specificity and detail through the use of the accompanying drawing(s), in which:

FIG. 1 is a perspective drawing of the method for communication using a leg covering, according to one embodiment of the invention;

FIG. 2 is a perspective drawing of the method for communication using a leg covering, according to one embodiment of the invention;

FIG. 3 is a cross-sectional side view of the method for communication using a leg covering, according to one embodiment of the invention; and

FIG. 4 is block diagram of a kit for communication using a leg covering, according to one embodiment of the invention.

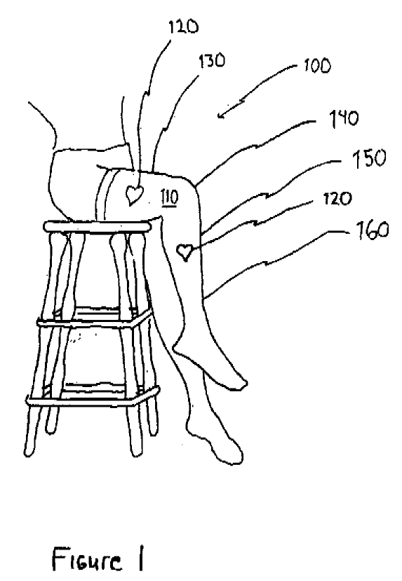

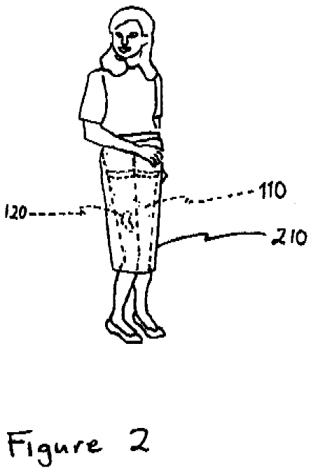

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

As shown by the figures, the illustrated method for communication 100 using a leg covering 110 includes steps of: selecting a graphical display 120 presenting a desired message 510; removably coupling the graphical display 120 via a coupling mechanism 310 to a thigh portion 130 of a leg covering 110 normally covered by another article of clothing 210, 520; and selectably displaying the graphical display 120, 530. The leg covering 110 may be any type of leg covering contemplated in the art, such as, but not limited to: panty hose 110, knee high socks, socks, thermal underwear, underwear extendable over a person's thigh, pants, leggings, and/or so forth. Indeed, any type of clothing and/or garment covering any part of the leg may be used. The leg covering 110 may be any type of color and/or size.

Additionally, shown in the figures, the illustrated method for communication 100 using a leg covering 110 includes selecting a graphical display 120 presenting a message. The graphical display 120 may include a drawing, picture, art, and/or or some other type of artistic or visual message and/or image. Some non-limiting examples of graphical displays include: a heart, an animal, a balloon, a traffic sign, and/or so forth. Alternatively, the graphical display 120 may include a logo or some form of text. Some non-limiting examples include: names; proper nouns; commands, such as, but not limited to, stop, go, kneel, sit, and/or so forth. Further, the graphical display 120 may include a combination of text and visual art. Additionally, the graphical display may include a variety of colors. In another embodiment, the graphical display comprises a color contrasting the color of the leg covering.

In another embodiment, the graphical display 120 is configured to cause a particular emotional response from either a wearer of the graphical display 120 or other person who views the graphical display 120. Some non-limiting examples of an emotional response include: happiness, sadness, excitement, intimacy, erotic feeling, and/or so forth.

In still another embodiment, the graphical display 120 displays an interest of the wearer. Some non-limiting examples of these graphical displays include: characters such as but not limited to Scooby-Doo (owned by Cartoon Network®); animals, such as, but not limited to: butterflies, horses, unicorns, etc.; musical notes showing an interest in music; a musical instrument showing an interest in a particular instrument; a trademark; a slogan; a political statement; a religious statement; a social statement; and/or so forth.

In another embodiment, the graphical display 120 is used to convey an emotion. Some non-limiting examples of these graphical displays include: a face showing an emotion; an emotive word or words such as but not limited to “happy,” “sad,” “go away,” and/or so forth.

In still another embodiment, the graphical display is used to create a valentine and/or a romantic message. Some non-limiting examples these graphical displays include: hearts having one or more messages thereon such as but not limited to “Be Mine,” “Kiss Me,” and/or “I'm Yours.” Moreover, the graphical display 120 may be configured to communicate a sexual message, such as but not limited to a provocative phrase, type, color, style, and/or so forth.

In yet another embodiment, the method for communication using a leg covering 110 includes selecting a plurality of graphical displays 120 and removably coupling a plurality of graphical displays 120 to a leg covering 110. The plurality of graphical displays 120 may include graphical displays 120 similar in size, appearance, and/or color. Conversely, the plurality of graphical displays 120 may be different in appearance, size, and/or color. Indeed, the plurality of graphical displays 120 may include any similarity and/or difference contemplated in the art. Additionally, the plurality of graphical displays 120 may include one or more pairs of graphical displays which are opposite and/or showing opposing images. Further, there may be a set of graphical images each showing an aspect of a group, such as, but not limited to: a set of emotive images, a set of letter, a set of interests, and/or so forth.

Additionally illustrated by the figures, the method for communication using a leg covering 110 includes removably coupling a graphical display 120 to a thigh portion 130 of a leg covering 110. In being removably coupled to a thigh portion 130 of a leg covering 110, the thigh portion 130 may be any place along the thigh portion 130 of a leg covering 110. The thigh portion 130 includes from a person's hip to a person's knee; both on the inner thigh and the outer thigh.

Additionally, as shown by the figures, the illustrated method for communication 100 using a leg covering 110 comprises a plurality of graphical displays 120 removably coupled to a portion of the leg covering 110 selected from the group consisting of: a thigh portion 130, a knee portion 140, a calf portion 150, and a shin portion 160. Indeed, the plurality of graphical displays 120 may be mixed and matched on one or all of the above portions of the leg covering 110.

In still another embodiment, the method for communication 100 using a leg covering 110 comprises a game. One skilled in the art would recognize there are multitude of different games that may be developed using a leg covering 110 and one or more graphical displays 120. In some non-limiting examples, the game may be of a sensual and/or erotic nature or may be whimsical and/or satirical. In one non-limiting example, the game includes a plurality of graphical displays 120 removably coupled to the leg covering 110, wherein each graphical display 120 includes and/or instigates a question and/or action for a game player. If a game player makes a correct response then he or she is allowed to move to the next graphical display 120. Additionally, in association with a game, the graphical display 120 may comprise stop and/or go signs; yes and/or no signs; numbers; letters; signals; awards; penalties; selectably displayable images; electronic displays; random image displays; and/or so forth.

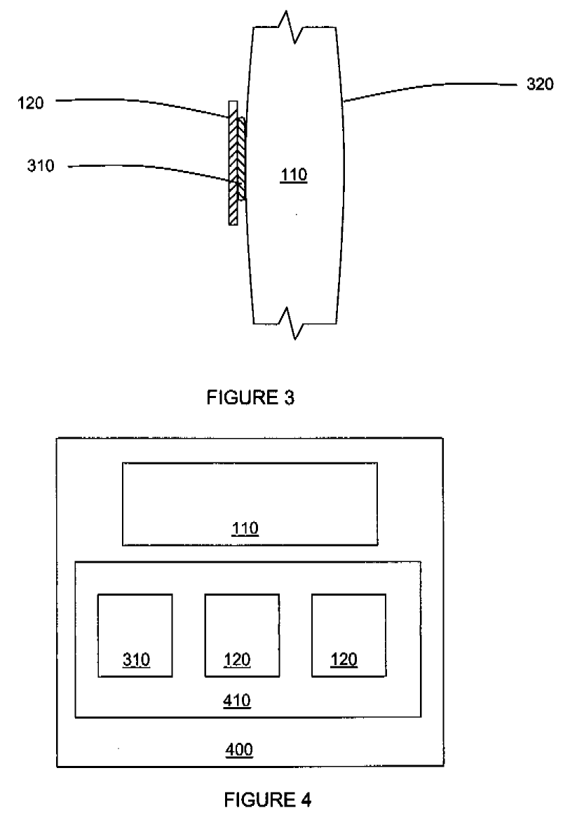

Also shown by FIG. 3, the illustrated method for communication 100 using a leg covering 110 includes a coupling mechanism 310 which is configured to easily removably couple one or more graphical displays 120 to a leg covering 110. A person skilled in the art would recognize there is a multitude of coupling mechanisms 310 available to easily removably couple one or more graphical displays 120 to a leg covering 110. Some non-limiting examples include: hook and loop, a velcro-like mechanism, an easily detachable adhesive substance, a snap, a button, and/or so forth. In enabling the one or more graphical displays 120 to be easily removably couplable to a leg covering 110, the coupling mechanism 310 should not require extensive stitching and/or sewing; but rather enable a user, with minimal effort, to remove and/or replace one or more graphical displays 120 on a leg covering 110.

In yet another embodiment, there is a method for communication 100 using a leg covering 110 comprising: wearing a leg covering 110 including a graphical display 120 easily removably couplable to the thigh portion 130 of the leg covering 610; and selectably covering and uncovering the graphical display 120, 620. The leg covering 110 may include any type of leg covering 110 contemplated in the art and/or as described previously.

In still another embodiment, the method for communication 100 using a leg covering 110 includes a game. A person skilled in the art would realize there is a multitude of games conceivable as described above.

In another embodiment, the method for communication 100 using a leg covering 110 may include selecting a plurality of graphical displays 120 and removably coupling the plurality of graphical displays 120 to a leg covering 110. The one or more graphical displays 120 may be removably coupled to a leg covering 110 in any manner contemplated in the art and/or as described previously. A person skilled the art would recognize there multitude of different combinations, sizes, and/or appearance of graphical displays 120 that are available to removably couple to a leg covering 110.

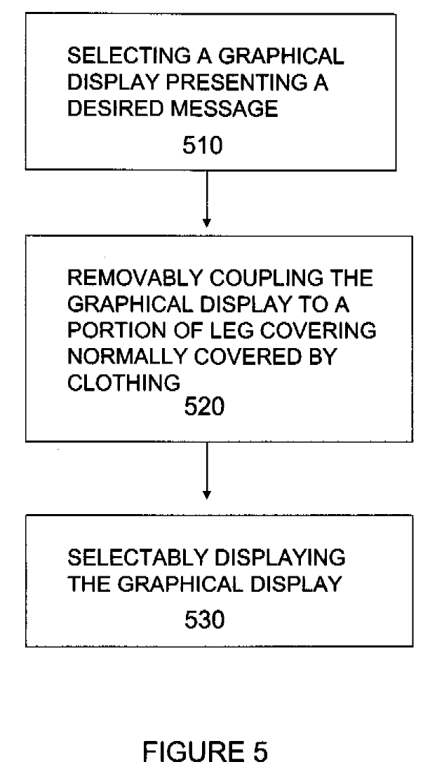

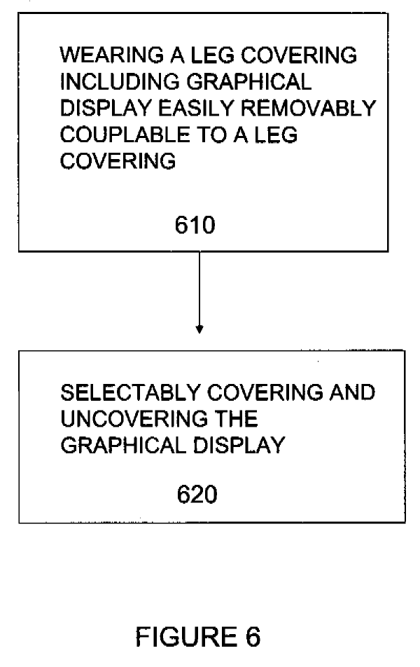

As illustrated by FIG. 4, there is a kit 400 for communication using a leg covering 110 comprising: a leg covering 110, configured to fit over a user's leg 320; and a communication system 410. The communication system 410 includes: a graphical display 120 removably couplable to the leg covering 110 at a location un-coverably covered by an article of clothing 210; and a coupling mechanism 310, configured to removably couple the graphical display 120 to the leg covering 110. The leg covering 110 may be any type of leg covering contemplated in the art and/or as described previously.

Additionally, as shown in the figures, the kit 400 for communication using a leg covering 110 includes a graphical display 120 which is removably couplable to the thigh portion 130 of a leg covering 110. The thigh portion 130 includes any meaning contemplated in the art and/or as described previously. The kit 400 further includes a plurality of graphical displays 120. The plurality of graphical displays 120 may be any type of graphical display contemplated in the art and/or as described previously. The one or more graphical displays 120 may comprise a game of any type contemplated in the art and/or as described previously.

Moreover, as shown in FIG. 4, the kit 400 for communication using a leg covering 110 further includes a coupling mechanism 310, configured to removably couple the graphical display 120 to the leg covering 110. One skilled in the art would recognize there is a multitude of coupling mechanisms 310 available to removably couple the graphical display 120 to a leg covering 110 and/or other coupling mechanisms 310 as described previously.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

Additionally, although the figures illustrate panty hose as a leg covering 110, any type of leg covering may be used as described herein. It is also envisioned that the kit 400 for communication using a leg covering 110 may be packaged in a variety of ways. One skilled in the art would realize there is a multitude of ways in which a kit 400 may be packaged and/or assembled. Some non-limiting examples of packaging include: boxes, bags, and/or so forth. Further, it is envisioned the kit 400 may be packaged with a variety of types, numbers, and/or colors of leg coverings 110 and/or graphical displays 120.

It is expected that there could be numerous variations of the design of this invention. An example is that the coloring of a leg covering 110 may be any color, size, and/or type.

Finally, it is envisioned that the components of the device may be constructed of a variety of materials. Some non-limiting examples of materials of leg coverings 110 include: nylon, cloth, wool, cotton, polyester, and/or combinations thereof. Some non-limiting examples of graphical display 120 materials include: plastic, cloth, ceramic, paper, ink, and/or so forth.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A method for communicating using a leg covering, comprising the steps of:
selecting a graphical display presenting a desired message;
removably coupling the graphical display via a coupling mechanism to a thigh portion of a leg covering normally covered by another article of clothing; and
selectably displaying the graphical display.

2. The method for communication of claim 1, further comprising the step of selecting a plurality of graphical displays; and removably coupling the plurality of graphical displays.

3. The method for communicating using a leg covering of claim 2, wherein the plurality of graphical displays comprises a game.

4. The method for communicating using a leg covering of claim 1, wherein the leg covering comprises panty hose.

5. The method for communicating using a leg covering of claim 1, wherein the coupling mechanism includes hook and loop.

6. The method for communicating using a leg covering of claim 1, wherein the graphical display is configured to cause a particular emotional response.

7. The method for communicating using a leg covering of claim 1, wherein the graphical display includes text.

8. The method for communicating using a leg covering of claim 1, wherein the graphical display comprises a color contrasting the color of the leg covering.

9. The method for communicating using a leg covering of claim 2, wherein the plurality of graphical displays are removably coupled to a portion of the leg covering selected from the group consisting of: a thigh portion, a calf portion, a shin portion, and a knee portion.

10. A method for communicating using a leg covering comprising the steps of:
wearing a leg covering including a graphical display easily removably couplable to the thigh portion of the leg covering; and
selectably covering and uncovering the graphical display.

11. The method for communicating using a leg covering of claim 10, further comprising the steps of:
selecting a plurality of graphical displays; and
removably coupling the plurality of graphical displays.

12. The method for communicating using a leg covering of claim 11, wherein the plurality of graphical displays comprises a game.

13. The method for communicating using a leg covering of claim 10, wherein the leg covering comprises panty hose.

14. The method for communicating using a leg covering of claim 10, wherein the coupling mechanism includes hook and loop.

15. A kit for communicating a message using a leg covering comprising:
a leg covering, configured to fit over a user's leg; and
a communication system removably coupleable to the leg covering, including:
a graphical display removably couplable to the leg covering at a location un-coverably covered by an article of clothing; and
a coupling mechanism, configured to removably couple the graphical display to the leg covering.

16. The kit for communicating a message using a leg covering of claim 15, wherein the graphical display is removably couplable to the thigh portion of the leg covering.

17. The kit for communicating a message using a leg covering of claim 15, further comprising a plurality of graphical displays removably couplable to the leg covering.

18. The kit for communicating a message using a leg covering of claim 17, wherein the plurality of graphical displays comprise a game.

19. The kit for communicating a message using a leg covering of claim 15, wherein the leg covering comprises panty hose.

20. The kit for communicating a message using a leg covering of claim 15, wherein the coupling mechanism comprises a hook and loop.
